(19) United States
(12) Patent Application Publication
(10) Pub. No.: US 2002/0152183 A1
(43) Pub. Date: Oct. 17, 2002

(54) Print supply marketplace using pricing model

(75) Inventors: Donald Soares, Chicago, IL (US); Jeffrey L. Rockwell, Pottstown, PA (US); Shishir Agarwal, New Rochelle, NY (US); Greg Portell, North Olmsted, OH (US)

Correspondence Address: SIDLEY AUSTIN BROWN & WOOD LLP, 717 NORTH HARWOOD, SUITE 3400, DALLAS, TX, 75201, US

(73) Assignee: A.T. Kearney, Inc.

(21) Appl. No.: 09/836,691

(22) Filed: Apr. 17, 2001

(51) Int. Cl. G06F 17/60; H04K 1/00; H04L 9/00; G06G 7/00; G06F 17/00

(52) U.S. Cl. 705/400; 705/37; 705/80

(57) ABSTRACT

A method for determining a price for a print job and a method for ensuring compliance with a pricing model. A computer system receives a set of specifications for the print job and calculates first and second estimated prices for the print job with respect to first and second printers. The estimated prices are based on pricing information provided by each of the printers for each of the components specified in the set of specifications. The first and second printers are informed of the set of specifications and the identity of the buyer. The printers can then contact the buyer to negotiate a portion of the specifications and arrive at a negotiated price.

### FIELD OF THE INVENTION

The present invention pertains to business marketplaces, and more particularly to a print supply marketplace using a pricing model.

### BACKGROUND OF THE INVENTION

The printed materials business is a custom-manufacturing business wherein specifications of a print job vary significantly on a job-by-job basis. Additionally, pricing of the print job also varies significantly, based on the printing processes used and the capabilities of a particular printer.

Many companies have continual need for printed materials. A large company, for example, may spend millions, or tens of millions, of dollars a year on print. The cost of a particular print job, however, is typically only on the order of several thousand dollars. Thus, the typical print purchaser tends to require a large number of relatively small print jobs, each with varying specifications.

Because of the large number of print jobs that are required each year, it is not practical, due to time and expense considerations, for a company to request price quotes from a number of printers for each individual print job. Therefore, the company may, on a periodic basis, select a small number of representative jobs and request price quotes for those jobs. The company can select its preferred printers based on the price quotes received. Then, as printed materials are required, the print jobs are channeled to the preferred printers.

Since the specifications of a particular print job may vary quite significantly from the representative jobs quoted, any price agreements that may have been reached with the printer will have limited utility as they are seldom valid across all the print needs of the company. This lack of pricing transparency and stability makes it difficult for the purchasing company to assess the cost of a printed product without getting bids from the printers on a job-by-job basis. For example, pricing for a particular job may vary by 20-30% between suppliers. Requesting bids on a job-by-job basis however, can result in higher production costs, process inefficiencies and delays for both the purchasers of the printed materials and the printers.

Thus, there is a need for a system that allows a buyer of printed materials to determine how much a specific print job should cost based on various factors, including the specifications of the print job and the processes used to produce a printed product corresponding to the specifications. Further, there is a need for a system that ensures compliance with a pricing model upon which the cost estimate is based.

### SUMMARY OF THE INVENTION

One aspect of the present invention is directed to a method for determining a price for a print job. A computer system receives a set of specifications for the print job and calculates first and second estimated prices with respect to first and second printers, respectively. The estimated prices are based on pricing information provided by each of the printers for each of the components in the set of specifications.

Once the estimated prices are calculated, the buyer is informed of at least the lower of the estimated prices. In one embodiment, the buyer is informed of the prices from all of the printers for which price estimates have been calculated (e.g., the first and second printers). The first and second printers are informed of the set of specifications and the identity of the buyer. The printers can then contact the buyer to negotiate a portion of the specifications and arrive at a negotiated price.

Another aspect of the present invention is directed to a method of ensuring compliance with a pricing model. A computer system receives a set of specifications for a print job and calculates an estimated price for the print job with respect to a printer. The estimated price is based on a pricing model, which is produced from pricing information provided by the printer.

As the buyer works with the printer to prepare the print job, the buyer or the printer may change a portion of the specifications, in effect producing a second set of specifications on which the actual print job is based. Once the print job is complete, the printer provides the buyer with an invoice based on the second set of specifications. The computer system estimates a price for the second set of specifications and compares this price to the invoice price to determine whether the invoice price complies with the pricing model.

### BRIEF DESCRIPTION OF THE DRAWINGS

A more complete understanding of the present invention and its advantages will be readily apparent from the following Detailed Description taken in conjunction with the accompanying drawings wherein like parts are designated by like reference numbers and in which:

FIG. 1 is a schematic illustration of a computer network for providing price estimates for a print job in accordance with the present invention;

FIG. 2 is a flow diagram illustrating a method, performed by a computer system, for creating a pricing model in accordance with the present invention;

FIGS. 3A and 3B are flow diagrams illustrating a method, performed by a computer system, for estimating a price for a print job in accordance with the present invention;

FIG. 4 is a flow diagram illustrating a method, performed by a computer system, for ensuring compliance with a pricing model in accordance with the present invention;

FIG. 5 is a state diagram illustrating a system for obtaining the paper required to produce a print job;

FIG. 6 illustrates selected portions of an exemplary set of specifications for printing a booklet;

FIG. 7 illustrates an example of an initial screen for entering pricing information;

FIG. 8 illustrates an example of a Prepress screen;

FIGS. 9A and 9B illustrate exemplary portions of an Input and Color Correction screen;

FIG. 10 illustrates an example of a Printing Prices screen;

FIG. 11 illustrates an example of a Sheet Fed screen;

FIGS. 12A and 12B illustrate exemplary portions of a Sheet Fed-8.50×11.00 screen;

FIGS. 13A and 13B illustrate exemplary portions of a Paper Rate Card screen; and

FIG. 14 illustrates an example of an Ink Coverage screen.

### DETAILED DESCRIPTION OF THE PREFERRED EMBODIMENTS

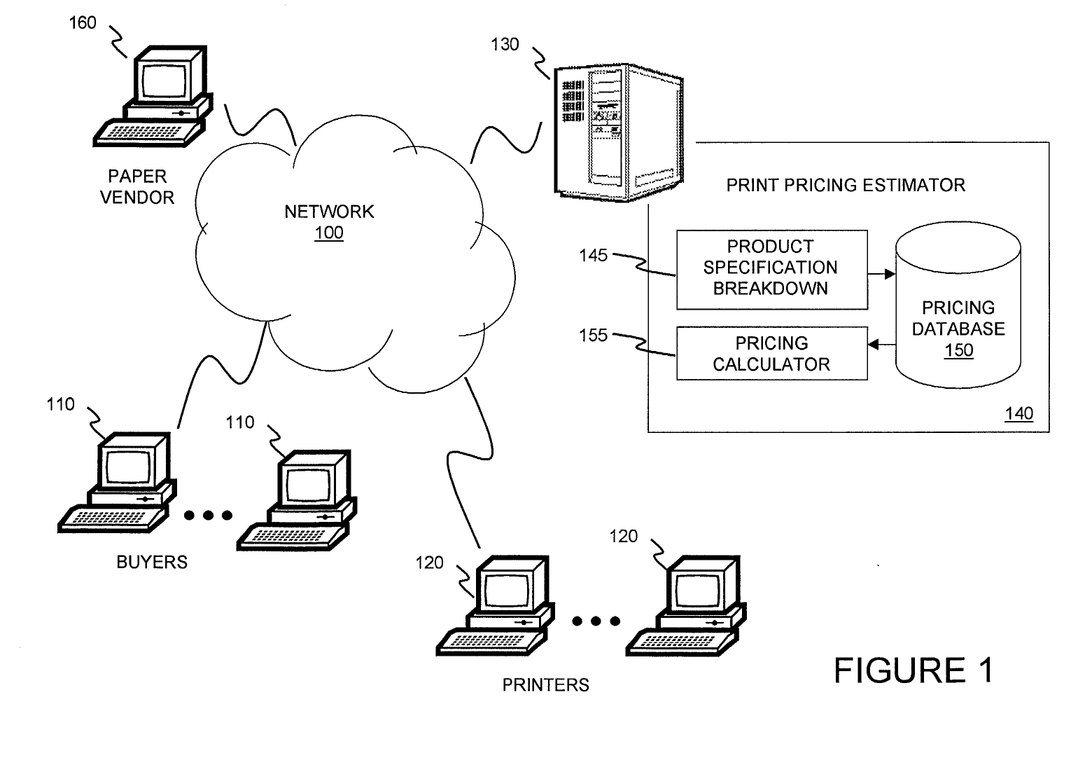

FIG. 1 schematically illustrates a hardware embodiment of the present invention. A network 100 provides an electronic communications medium that connects buyers at buyer computers 110 and printers at printer computers 120 to a print marketplace computer system 130 incorporating a print pricing estimator 140. A paper vendor at a paper vendor computer 160 is also connected to the print marketplace computer system 130 via the network 100.

The buyer computers 110, printer computers 120, paper vendor computer 160, and print marketplace computer system 130 may include personal computers, workstations, or servers. The computers 110, 120, 130 may be coupled to the network 100 via a wired or wireless communication system or any combination thereof. The network 100 can be a private network, a public network, or any combination of private and public networks, including local area networks (LANs), wide area networks (WANs), or the Internet.

The print pricing estimator 140 is designed to enable a buyer to determine the estimated cost of a print job based on a set of specifications for the print job submitted to the computer system 130 by the buyer computer 110. The price of the print job may vary depending on the printers and the particular print processes used in producing the print job.

The print pricing estimator 140 captures pricing information at a component level for each operation in a print job. This component level pricing is collected from multiple printers and spans different printing processes. A product specification breakdown 145 breaks a required print job down into a number of operations and components. A pricing calculator 155 retrieves pricing information from the pricing database 150 for each of the components of the print job to produce a total price for the print job.

A print job may include multiple items. For example, a booklet may include a cover, inside pages, and other items, such as a reply card, that are bound together. Pricing for a job is a combination of the charges for all of the items. Additionally, there are job level charges that are added in calculating the overall price. For example, each item will have print charges and paper charges associated therewith. Further, item level finishing charges may be included, such as charges for trimming, folding, scoring, etc. Job level charges such as finishing and packaging costs are also added to arrive at the price for the print job.

In one embodiment of the present invention, certain elements are not covered by the pricing model. Pricing for such elements may be provided by the individual printers as needed. Thus, the pricing model may avoid unnecesary complexity due to the inclusion of elements that are rarely required, or do not significantly affect the final pricing.

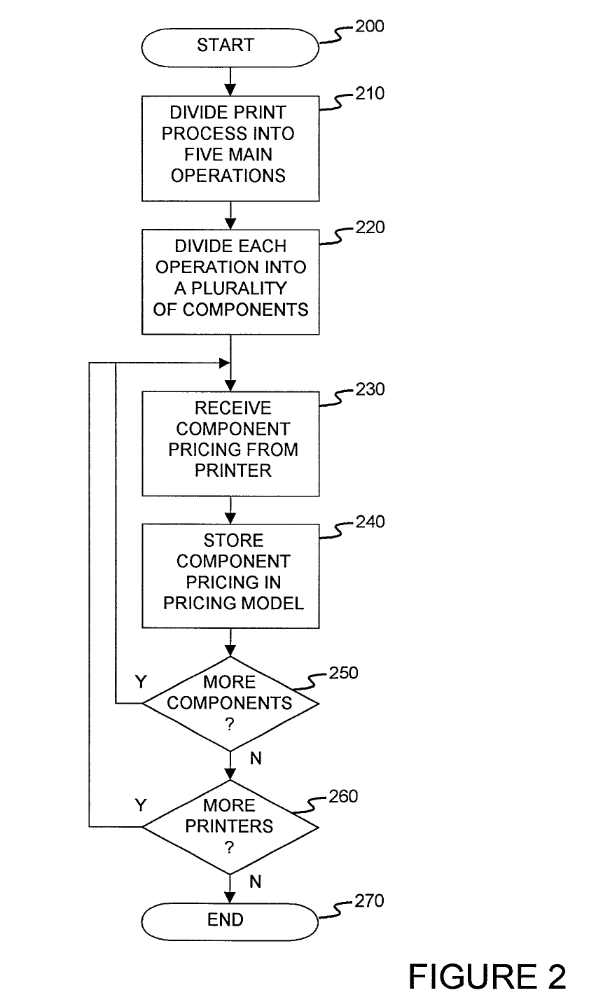

FIG. 2 is a flow diagram illustrating the operation of the computer system 130 in creating a pricing model. The method starts at step 200. In step 210, the print process is divided into five main operations: i) prepress, ii) print, iii) paper, iv) finishing, and v) packaging. Other ways of dividing up the printing process are possible and are within the scope of the invention. Once the pricing for each of the main operations has been determined, the total cost of the print job is calculated by adding the pricing (or by applying the multiplier factors) for each operation.

A single operation may have multiple components. For example, the finishing requirements for a brochure may include folding, scoring, trimming, and other combinations of finishing components. In step 220, each of the five main operations is divided into a plurality of components. Typically, only a portion of the available components are utilized for a particular print job. Charges for all the applicable components in an operation are added together to provide the total cost for the operation.

In step 230, pricing data is collected from the printer for every component of the printing process that the printer is capable of performing. For each component, data is collected and arranged so as to capture many of the possible variations, particularly any variations that can affect pricing in a significant manner. These variations can be captured, for example, through multiple tables and cost break ups, multiple cells within a table, and cost multiplier factors. In one embodiment of the present invention, up to 8000 data points may be collected from a printer for use in forming the pricing model for that printer. In another embodiment, pricing is collected with respect to only certain data points. For example, pricing data for print runs may be collected at 1,000, 5,000, 10,000, 25,000, 50,000, 100,000, and 250,000 units.

In step 240, the pricing data is received by the computer system 130 and stored in the pricing database 150. A decisional step 250 then determines whether there are components remaining for which pricing data has not been received from the printer. If so, the method repeats steps 230 and 240 wherein the computer system 130 receives pricing data for the remaining components until the pricing data for all the applicable components has been received. The method then continues to step 260 once all the applicable pricing components have been received and stored in the pricing database 150.

A decisional step 260 determines whether there are more printers for which pricing information has not been received. If so, the method repeats steps 230 and 240 wherein pricing data is received and stored in the pricing database 150 for each component applicable to another printer. The information in the pricing database 150 can thus be used to calculate estimated prices for a print job with respect to a number of different printers. The method then ends at step 270.

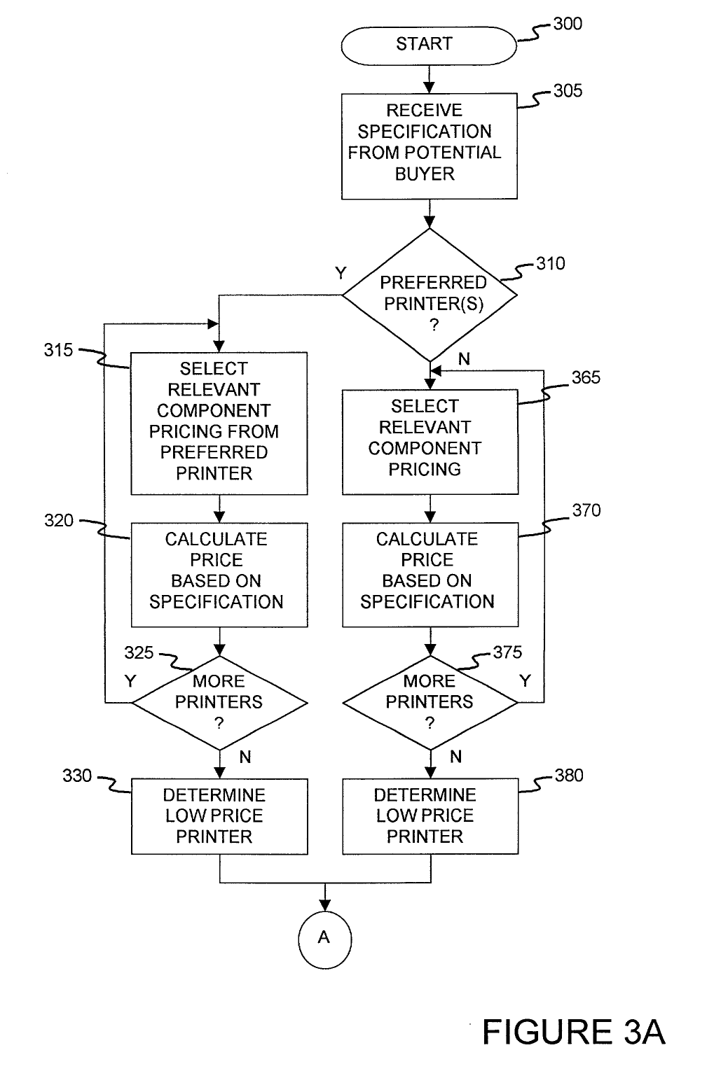

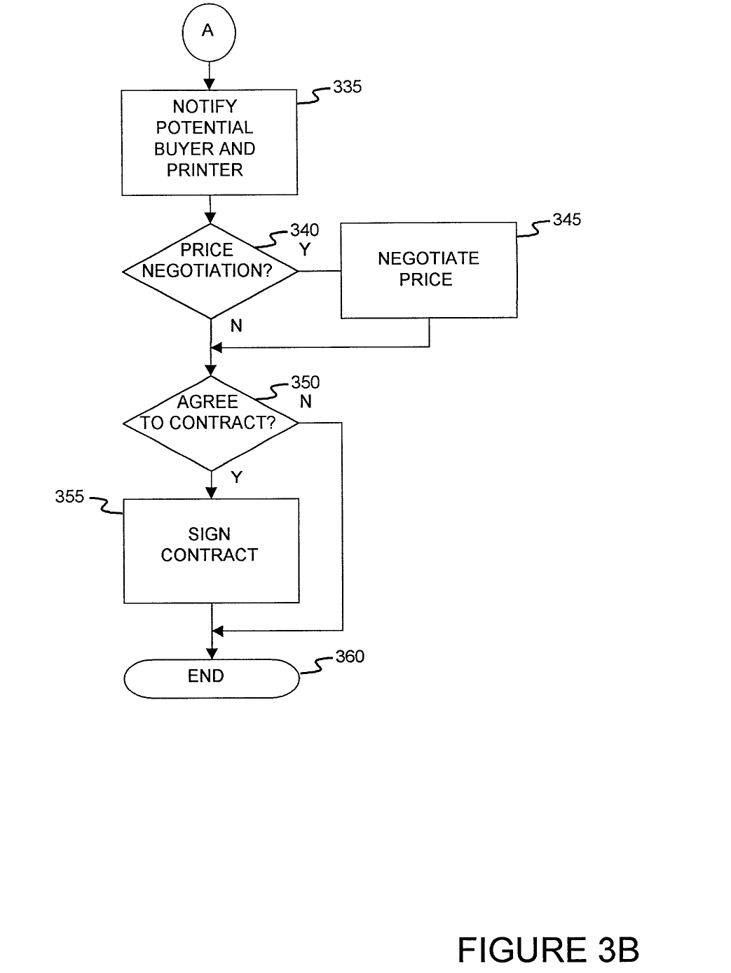

FIGS. 3A and 3B are flow diagrams illustrating the operation of the computer system 130 in estimating a price for a print job. The method starts at step 300. At step 305, a set of specifications detailing a print job is received from a buyer. The buyer can transmit the set of specifications to the computer system 130, for example, from the buyer computer 110 via the network 100.

In a preferred embodiment, the marketplace is closed and qualified. Printers are preferably prequalified to participate in the marketplace based on both qualitative and quantitative factors. A plurality of qualitative factors may be considered, including the printer's business structure (size in terms of revenue or number of employees, diversity), printing capabilities (product breadth, inventory, turnaround), account management (customer service), reporting capabilities, quality certifications, technology, and the type and amount of discounts available. Quantitative evaluation of the printers can be performed by analyzing a large number of pricing components entered by the printer in the pricing estimator model.

In a decisional step 310, the computer system 130 determines whether the buyer has designated certain printers as preferred printers. Preferred printers may be selected (from the prequalified printers) based on, for example, the buyer's prior experiences with the printer, or the printer's geographic location in relation to that of the buyer. Preferred printers may also be selected based on their quality certification level. Some printers may be certified to ISO 9000, 9001, or 9002 standards, and may be selected based on such certification. Satisfaction information can also be collected, with the printers being selected based on a particular level of satisfaction desired. Pricing estimates are then performed using the pricing information provided by the preferred printers and stored in the pricing database 150.

The buyer may also add or remove printers from the buyer's list of preferred printers or select a particular printer (from the prequalified printers) for just the current print job, wherein the selected printer is considered to be a preferred printer for only the current print job.

If the buyer has designated preferred printers, the method continues to step 315, wherein the relevant component pricing associated with one of the preferred printers is retrieved. In step 320, an estimated price for the print job is calculated based on the set of specifications and the component pricing provided by that printer.

The estimated price includes both a manufacturing component and a raw material component (e.g., paper cost). The manufacturing component is calculated based on the pricing information provided by the printer(s). The raw material component is based on the type and amount of paper required, which may vary based on the processes and equipment used by a particular printer.

Pricing information is preferably collected with respect to only certain data points and can be interpolated for all other data points. For example, if the set of specifications requires pricing information for which there is not an exact match in the pricing model, the information required can be determined by interpolating from the data points that are available in the pricing model.

Then, in step 325, the method determines if pricing estimates need to be calculated with respect to other printers. If so, steps 315 and 320 are repeated to calculate estimated prices for the print job with respect to these other preferred printers. Once there are no more preferred printers remaining, the method continues to step 330, wherein the low price printer is determined.

In step 335, the buyer is informed of at least the lowest estimated price for the print job and, preferably, the identity of the low price printer. The buyer may also be informed of the other estimated prices for the print job for comparison purposes. In one embodiment, the buyer is informed of all the price estimates that have been calculated, along with the identities of the associated printers.

The computer system 130 can make the set of specifications available to the preferred printer(s), preferably via the network 100, and also provide the identity of the buyer to the printers. Thus, in step 340, the printer has the option of reviewing the set of specifications and the estimated price and negotiating with the buyer to arrive at a price that is lower than the estimated price.

In one embodiment of the present invention, the pricing model is a maximum cost model, wherein the prices provided by the printers reflect the maximum cost of each component. Upon reviewing the set of specifications, the printer may realize that the print job can be profitably performed at a price lower than the estimated price provided by the print pricing estimator 140. The printer can therefore contact the buyer and propose a lower price for the print job. The printer can communicate with the buyer via the network 100 or can contact the buyer using conventional means, such as by telephone, fax, etc.

In some cases, a print job may be performed by one of a number of different processes. While the buyer may have specified a particular print process, the printer may be aware of another process for producing a substantially similar product, but at a reduced price. In step 345, the printer can use this opportunity to suggest a change in the set of specifications, which will result in a lower price for the print job. Once a negotiated set of specifications and a negotiated price has been agreed upon (Yes in step 350), the parties can sign a job estimate (or contract) for the print job in step 355. The job estimate may be signed electronically through the use of digital signatures. Alternatively, the computer system 130 can send contracts to the buyer and printer for manual execution. The method then ends with step 360.

Previously, in the decisional step 310, the buyer had designated certain printers as preferred printers. If, however, the buyer has not designated any preferred printers and decides not to select any printers, the printer may be selected by the computer system 130 based on the set of specifications submitted by the buyer. For example, some printers may be equipped to perform larger print jobs and thus are more cost effective for these large jobs, while other printers may be more suited to producing smaller print jobs. The computer system 130 can thus select the printers that are most appropriate for the print job. Additionally, depending on the volume of materials to be printed, the computer system 130 may select printers based on their geographical proximity to the buyer to minimize delivery costs.

In step 365, the relevant component pricing associated with one of the selected printers is retrieved from the pricing database 150. In step 370, the print pricing estimator 140 calculates an estimated price for the print job based on the set of specifications.

To provide a range of estimates, the computer system 130 generally selects more than one printer and compares the price estimates from the printers selected. In step 375, the method determines if price estimates are required to be calculated with respect to more printers. If so, steps 365 and 370 are repeated as the print pricing estimator 140 calculates the estimated prices for the print job with respect to these other printers. Once there are no more printers, the method continues to step 380, wherein the low price printer is determined. The buyer is then informed of the estimated price for the print job and, preferably, the identity of the low price printer.

The method then continues with steps 335-360 as previously discussed, wherein the computer system 130 makes the set of specifications available to the printers, identifies the buyer, and allows the buyer to negotiate the set of specifications and the corresponding price with the printers. Once a negotiated set of specifications and a negotiated price has been agreed upon, the parties may sign a contract for the print job and the method ends at step 360.

The print industry is one in which buyers and printers work closely together in producing a final product and in which the specifications for a product can vary quite significantly from the time the contract is signed by the buyer and the printer to the time the product is actually printed. For example, a buyer may initially submit a set of specifications requiring a 12 page brochure having six colors on each page. The printer provides the buyer with a price based on the specifications and a contract is signed whereby the printer and buyer agree to the price and the specifications. As the brochure is designed and laid out, however, the buyer may realize that the 12 pages that were originally contracted for is inadequate for the amount of material the buyer wishes to include in the brochure and that 16 pages are required. The buyer may also have replaced some of images originally selected with other images. Thus, only four colors are required for the brochure, rather than the six colors originally contracted for.

Since the price provided by the printer is only effective for the 12 page, six color brochure, the printer is no longer bound by the contracted for price and thus can charge the buyer any price that the printer wants to charge. The buyer is at a disadvantage because the printer cannot be held to the contract pricing in light of the change in specifications. Further, the buyer is usually under time pressure to produce the print job and may not wish to request price quotes from other printers at this late date.

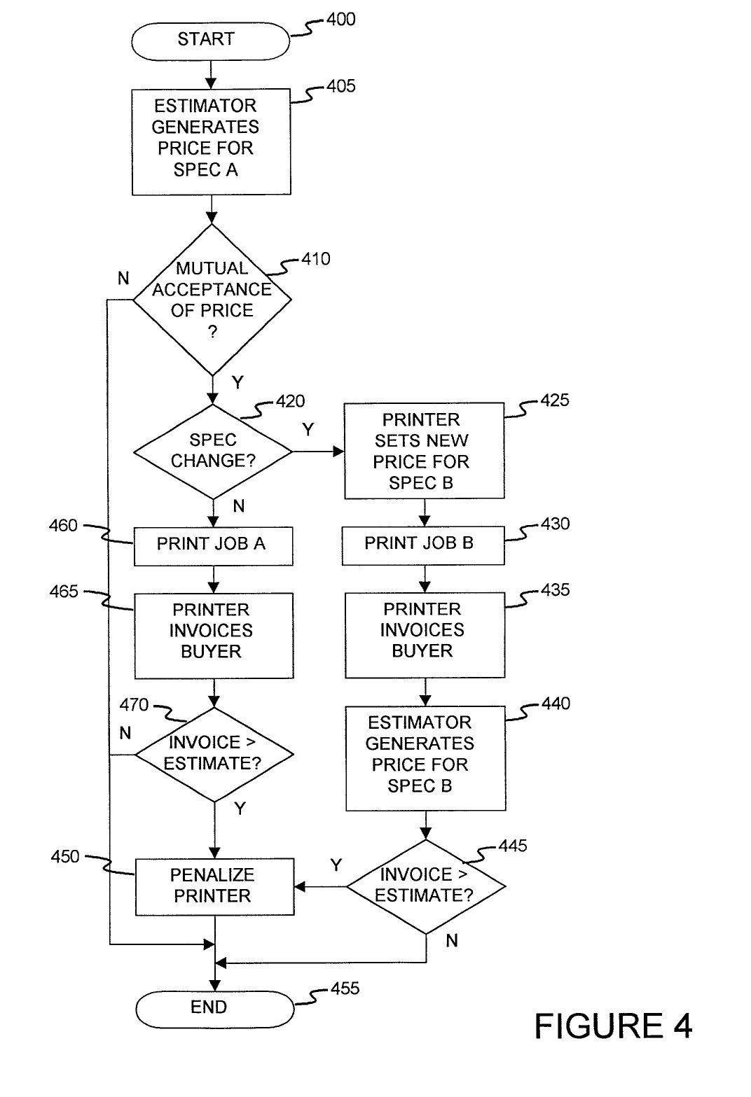

The present invention can advantageously use the pricing model discussed above to provide a price control structure for the buyer. FIG. 4 is a flow diagram illustrating the operation of the computer system 130 in ensuring compliance with the pricing model. The method starts at step 400. In step 405, the print pricing estimator 140 generates a price estimate for an initial set of specifications (SPEC A). Assuming that the buyer and the printer both accept the price (Yes in step 410), the method continues to step 420. In step 420, the buyer or the printer can change the set of specifications originally agreed upon. If the set of specifications is changed (e.g., to SPEC B) (Yes in step 420), the method continues to step 425, wherein the printer sets a new price for the print job. In one embodiment, the printer can set the new price with the aid of the pricing model so as to be in compliance therewith. The printer can also set an invoice price and check with the model before invoicing the buyer to ensure compliance. Of course, the printer can set the price without using the pricing model. The printer then produces the print job in step 430 and invoices the buyer in step 435.

In step 440, the print pricing estimator 140 receives the set of specifications that resulted in the print job (SPEC B) and generates a price estimate based thereon. Then, in step 445, the computer system 130 compares the invoice price to the price estimate to determine whether the invoice price is higher than the estimated price. If the invoice price is substantially higher than the estimated price (for example, 5% higher), the system 130 determines that the printer has overcharged the buyer and penalizes the printer (step 450). The printer may, for example, be forced to reimburse the buyer the difference between the invoice price and the estimated price, plus an additional percentage of the price as a penalty. In more egregious cases, the printer can be assessed a greater penalty or even be denied participation in the print supply marketplace. The method then ends at step 455.

In the decisional step 420, if there are no changes to the specifications, the print job is printed in step 460 and the printer invoices the buyer in step 465. Then, in step 470, the computer system 130 compares the invoice price to the estimated price to determine whether the invoice price is substantially higher than the estimated price. If so, the printer can be penalized in step 450. The method then ends at step 455.

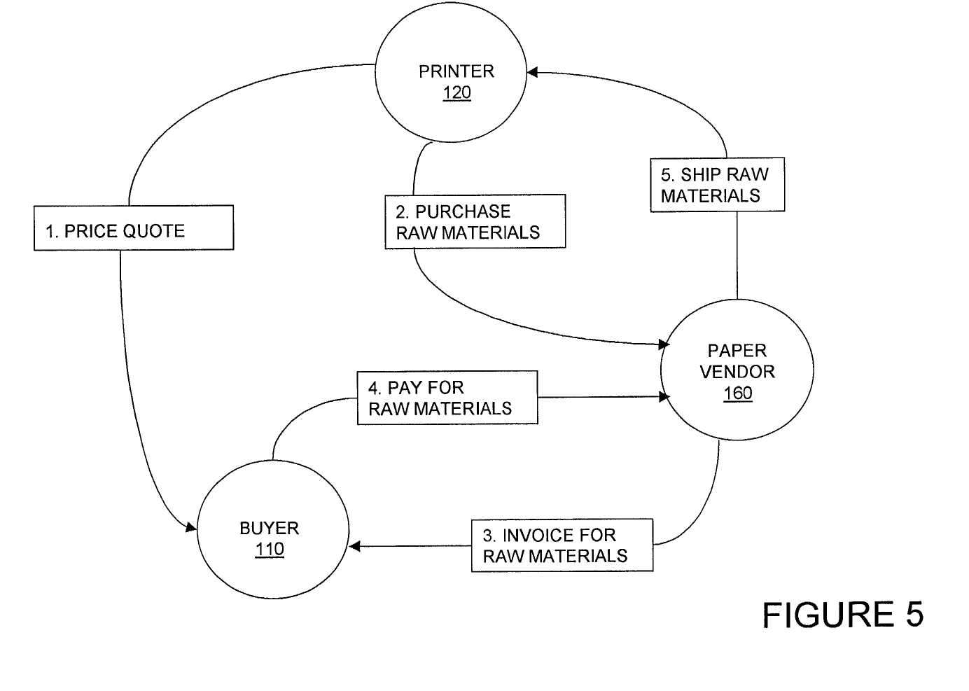

FIG. 5 is a state diagram illustrating a method for obtaining the paper needed to produce a print job. The entities illustrated are the same as those shown in FIG. 1. The method is shown in sequential steps as follows.

1. Price Quote.

Upon receiving the set of specifications from the buyer and the estimated price from the print pricing estimator 140, the printer can contract with the buyer based on the price estimated by the print pricing estimator 140 or negotiate with the buyer to provide the buyer with a reduced price. In one embodiment, the price provided by each printer includes only the manufacturing costs. The pricing model then calculates the amount of paper needed for each of the selected printers and adds the cost of the paper to produce a total price for the print job. Each printer may require a different amount of paper to produce the same print job, due to their different efficiencies and to the different equipment that are used in producing the print job.

2. Purchase Raw Materials.

Once the price has been agreed to and the contract or price estimate is signed, the printer orders the paper from the paper vendor. In one embodiment, the paper vendor only supplies paper to the printer. In another embodiment, the paper vendor can supply the printer with paper and other raw materials, including toner, cleaning solvents, inks, plates, and chemicals. An agreement may exist which provides for a preferred paper vendor to supply all the paper needed by all the printers participating in the print marketplace. Alternatively, the printer may purchase paper from one of a selected group of paper vendors.

3. Invoice for Raw Materials.

Upon ordering the paper, the printer informs the paper vendor of an identity of the buyer. The paper vendor can then directly invoice the buyer for the cost of the paper (and, optionally, other raw materials) required to produce the print job.

4. Pay for Raw Materials.

The buyer pays the paper vendor directly for the paper and, optionally, the other raw materials. The buyer can thus pay a lower price for the paper since the buyer is, in effect, purchasing the paper directly from the paper vendor and does not have to pay for any surcharges that the printer would have included. Further, the buyer may actually purchase a greater amount of paper on an annual basis than the printer and, therefore, have greater leverage over the paper vendor in setting the price of the paper. The buyer may thus be able to obtain the paper at a lower price than the printer. Therefore, in one embodiment, the price for the paper is shielded from the printer in order to protect the paper vendor.

In another embodiment, the paper vendor can contact the buyer to negotiate the type or amount of paper required. For example, although the buyer may have specified a certain type of paper, the paper vendor may be able to obtain a different type of paper that, while still suitable for the print job, may be obtained at a much lower price. The paper vendor can contact the buyer and suggest a change in the set of specifications to accommodate this type of paper.

5. Ship Raw Materials.

The paper vendor can ship the paper directly to the printer for use in producing the print job and invoice the buyer. Typically, the paper vendor performs a credit check on the buyer and ships the paper before receiving payment.

One embodiment of the present invention monitors the paper vendor to ensure that the paper vendor complies with an agreed upon pricing agreement. The paper vendor can then be penalized for overcharging the buyer.

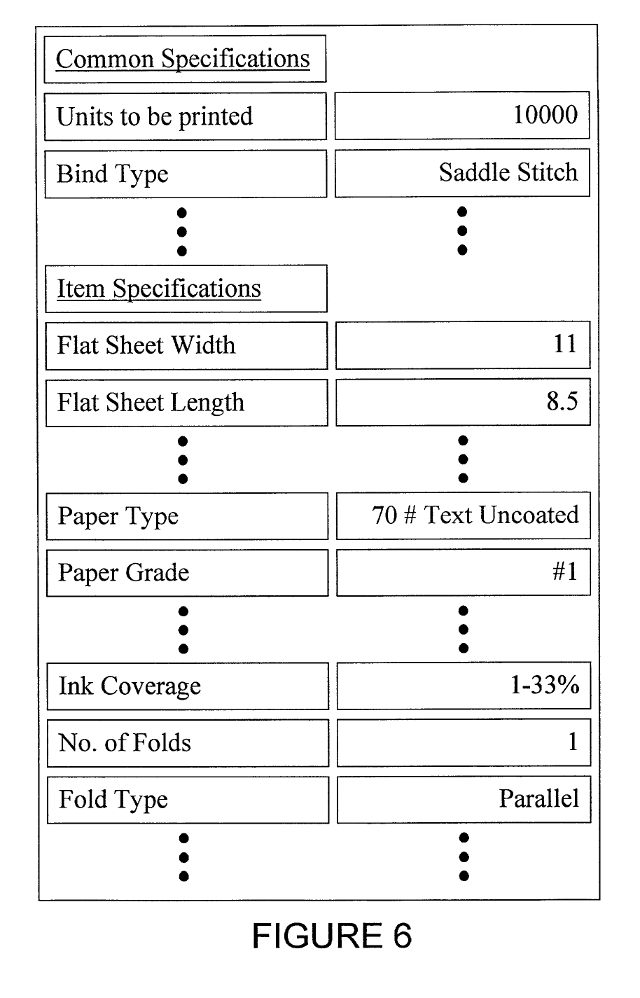

FIG. 6 illustrates an example of selected portions of a set of specifications for a booklet. The specifications include such information as the number of units required, the type of binding to be used, the paper size (including length and width), the paper type and grade, the amount of ink coverage, and the number and type of folds required to produce the booklet. Any information that is considered to be pertinent in producing a price estimate for the booklet are included in the set of specifications.

To get a price estimate for the booklet, for example, the buyer can access the computer system 130 and fill in the various fields. Once all the pertinent fields are filled in, the print pricing estimator 140 can access the pricing database 150 and determine the cost of the print job, in this case, the booklet.

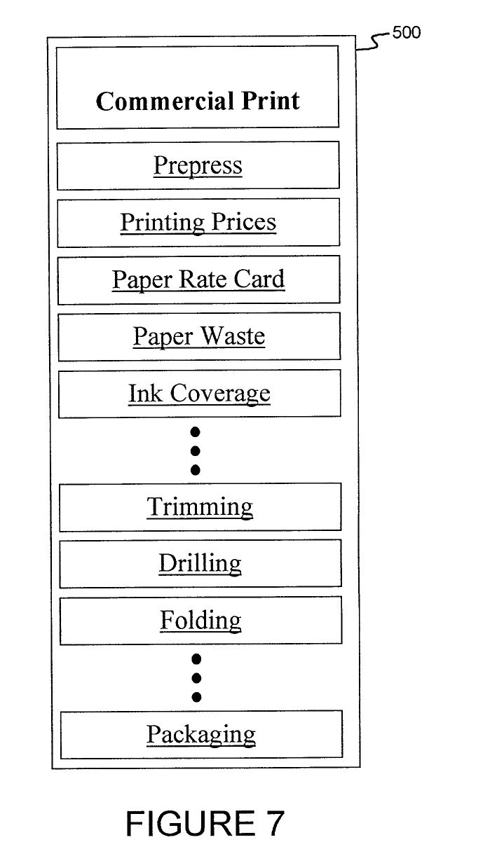

FIGS. 7-14 illustrate one embodiment of a system by which a printer can enter pricing information into the pricing database 150. The computer system 130 can generate a number of screens (e.g., web pages) for display on the printer computer 120. The printer can access the screens to input pricing information into the pricing database 150.

FIG. 7 is an example of a screen display wherein a commercial print process has been divided into a plurality of operations and components. A printer participating in the print marketplace can access the computer system 130, for example, via a website accessible from the Internet. Once at the website, the printer can access the Commercial Print screen 500 and systematically step through each print operation and enter the relevant pricing for each component of the operation.

The Commercial Print screen 500 may include selections of operations such as Prepress, Printing Prices, Paper Rate Card, and Packaging. Additionally, the Commercial Print screen 500 may include selections of various components of an operation (e.g., the Trimming, Drilling, and Folding components of the Finishing operation).

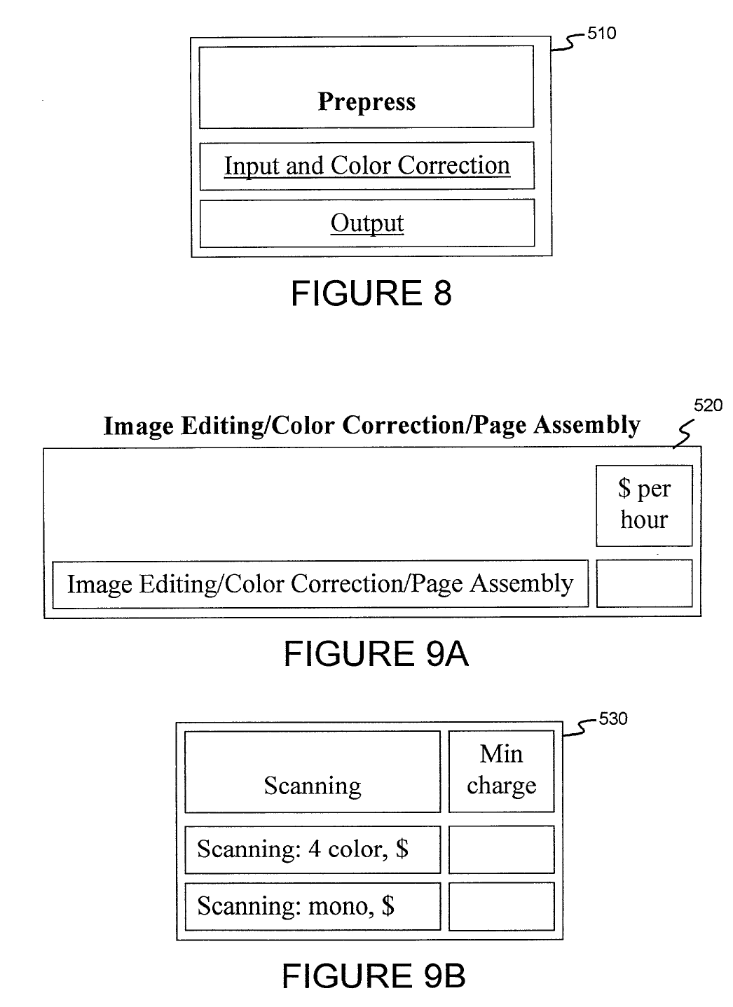

FIG. 8 is an example of a Prepress screen 510. Upon selecting the Prepress operation from the Commercial Print screen 500, the printer will be presented with the Prepress screen 510 and given the option of entering pricing for 1) Input and Color Correction or 2) Output.

FIGS. 9A and 9B are examples of screen displays illustrating selected portions of the Input and Color Correction screen. Assuming the printer selects the Input and Color Correction screen, the printer will be presented with a screen containing the Image Editing/Color Correction/Page Assembly table 520, wherein pricing information, such as the charge per hour for image editing, color correction, and page assembly services, can be entered. The Input and Color Correction screen may also contain a Scanning table 530 wherein the printer can enter pricing information relating to scanning services. In the illustrated embodiment, the Scanning table 530 includes fields for entering different rates for the different types of scanning to be performed by the printer. Other related tables can also be included in the Input and Color Correction page as may be advantageous.

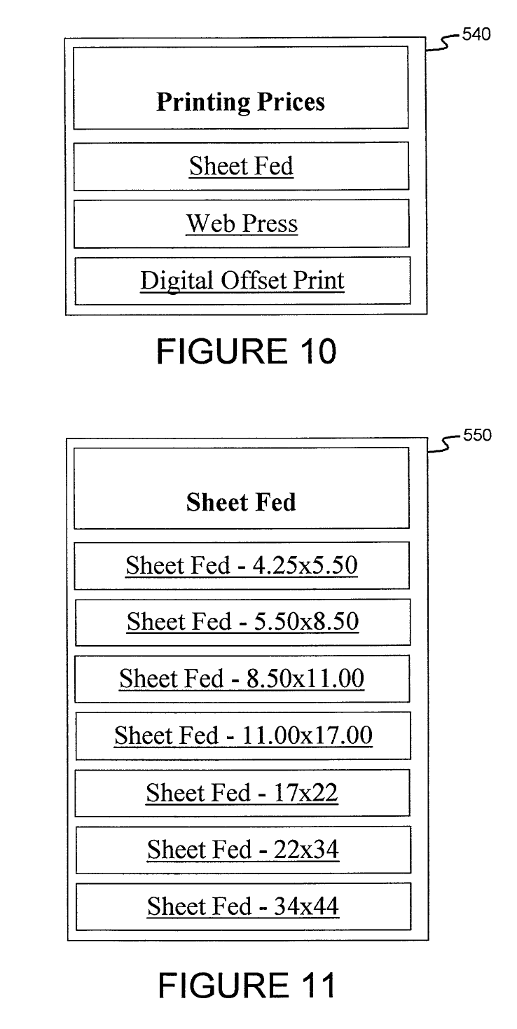

FIG. 10 is a screen display illustrating an example of a Printing Prices screen 540. The Printing Prices screen 540 of the present embodiment includes three options: Sheet Fed, Web Press, and Digital Offset Print. Selection of each of the options presents the printer with an appropriate screen for entering pricing data with respect to that option.

FIG. 11 is a screen display illustrating an example of a Sheet Fed screen 550. Upon selecting the Sheet Fed option from the Printing Prices screen 540, the printer will be presented with the Sheet Fed screen 550. The Sheet Fed screen 550 again presents the printer with a variety of options, including a page for each of the various sizes of paper that can be printed in a sheet fed printer.

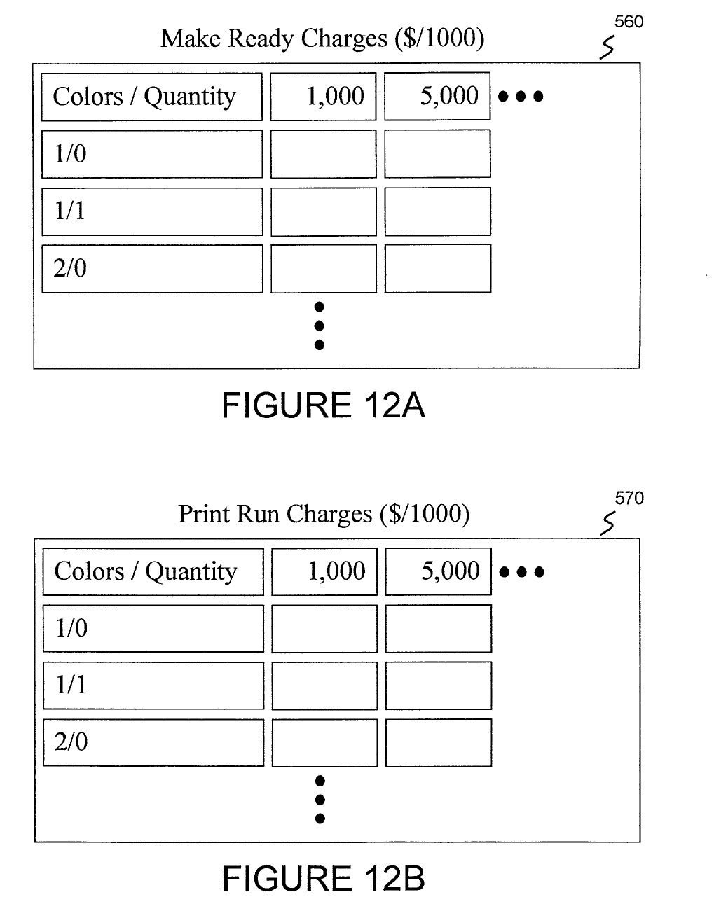

FIGS. 12A and 12B are screen displays illustrating exemplary portions of the Sheet Fed-8.50×11.00 screen. Upon selection of the Sheet Fed-8.50×11.00 option from the Sheet Fed table 550, the printer will be presented with the Sheet Fed-8.50×11.00 screen, which includes a Make Ready Charges table 560 and a Print Run Charges table 570. The Sheet Fed-8.50×11.00 screen allows the printer to enter pricing based on 8.50×11.00 paper. Pricing with respect to different sizes of paper can be entered in the appropriate screen selected from the Sheet Fed screen 550.

The Make Ready Charges table 560 summarizes the costs of preparing for a print run, including making and hanging print plates, loading ink towers, making size adjustments, and setting the press to run the print job. The Make Ready Charges table 560 is divided into a number of rows and columns to allow the printer to offer price breaks based on the quantity of the printed materials required and the number and quantity of colors required.

The Print Run Charges table 570 includes such charges as the price of ink, the cost of operating the machines, overhead, and other costs associated with actually printing the print job. Like the Make Ready Charges table 560, the Print Run Charges table 570 is divided into row and columns to allow for specific pricing information to be entered by the printer.

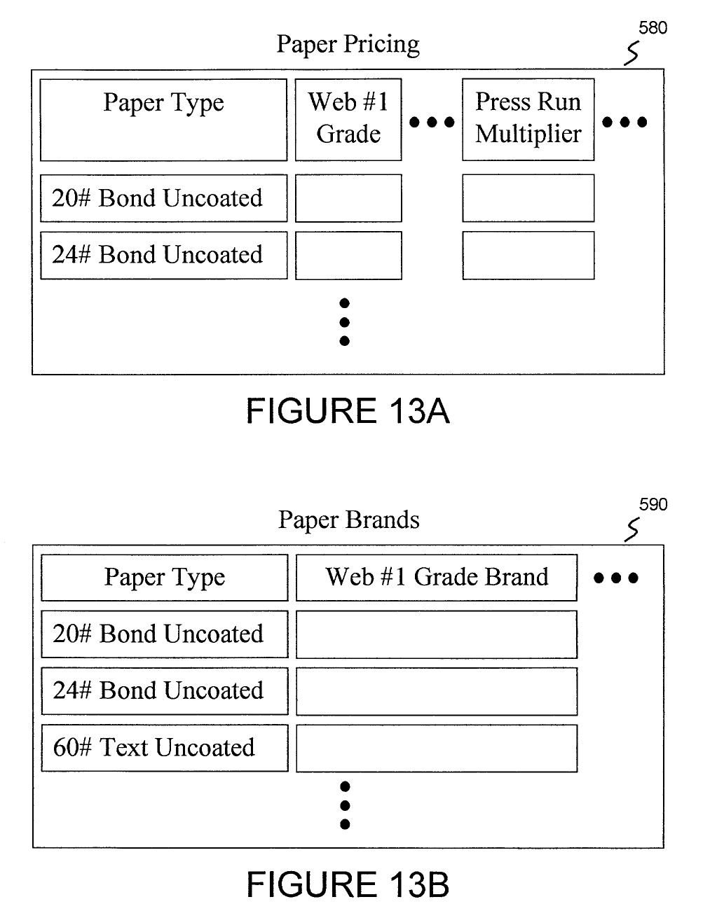

FIGS. 13A and 13B are screen displays illustrating exemplary portions of the Paper Rate Card screen, which can be accessed via the Commercial Print screen 500. Upon selection of the Paper Rate Card option, the printer will be presented with the Paper Pricing table 580 and the Paper Brands table 590. Pricing with respect to the types and brands of paper can be entered in the appropriate screen and stored in the pricing database 150.

The Paper Pricing Table 580 includes the costs of various paper grades, types, weights, coatings, etc. The Paper Pricing Table 580 also includes multiplier factors to be applied to the cost of the paper, including a press run multiplier factor and a fold multiplier factor. Pricing is preferably quoted in a price per pound format, but alternatively, can be presented as price per hundred weight or other convenient formats. The Paper Brands table 590 allows the brand of each type of paper to be identified.

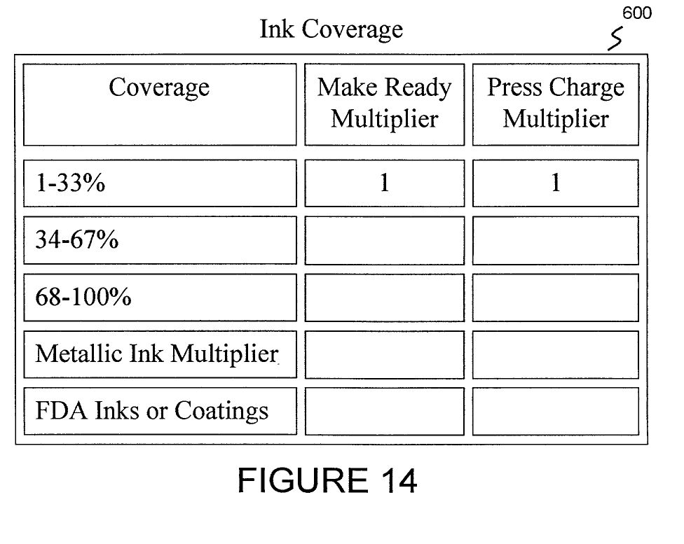

FIG. 14 is a screen display of an example of an Ink Coverage table 600. The Ink Coverage table 600 includes multiplier factors based on the amount of ink coverage and the type of ink used. The Ink Coverage table 600 includes a first column for a Make Ready Multiplier and a second column for a Press Charge Multiplier. The make ready and press costs can vary depending on the amount of ink coverage in a particular print job. For example, a print job requiring 70% ink coverage will require more ink than a job requiring only 20% ink coverage. Thus, the Ink Coverage table 600 allows the additional cost of ink to be factored in to the cost of the print job.

In summary, the present invention comprises a method for determining price estimates for a print job based on pricing information provided by a number of printers for each component of a set of specifications for the print job. The printers are informed of the set of specifications and can contact the buyer to negotiate a portion of the set of specifications to arrive at a negotiated price.

The present invention also provides a method for ensuring compliance with the pricing model. The set of specifications may change, resulting in a price change. The new set of specifications can be entered into the pricing model for calculating a new price estimate, which can then be compared to an invoice price provided by the printer.

Although the present invention has been fully described by way of examples and with reference to the accompanying drawings, it is to be understood that various changes and modifications will be apparent to those skilled in the art without departing from the spirit and scope of the invention. Therefore, unless such changes and modifications depart from the scope of the present invention, they should be construed as being included therein.

What is claimed is:

1. A method, using a computer system, for determining a price for a print job, comprising the steps of:
receiving, from a buyer, a set of specifications for said print job, wherein said set of specifications specifies at least a portion of a plurality of components into which a print process is divided, said portion thus specified being required to produce said print job;
calculating a first estimated price for said print job with respect to a first printer based on pricing information provided by said first printer for each of said components thus specified;
calculating a second estimated price for said print job with respect to a second printer based on pricing information provided by said second printer for each of said components thus specified;
informing said buyer of at least a lower of said first and second estimated prices; and
informing said first and second printers of said set of specifications and an identity of said buyer so as to allow at least one of said first and second printers to contact said buyer to negotiate at least a portion of said set of specifications, wherein said buyer may select one of said first and second printers based on a negotiated set of specifications and a corresponding negotiated price.

2. A method as recited in claim 1, further comprising the step of storing, in said computer system, said negotiated set of specifications and said corresponding negotiated price.

3. A method as recited in claim 1, wherein said negotiated set of specifications is identical to said set of specifications received from said buyer and wherein said negotiated price is less than or equal to said lower of said first and second estimated prices.

4. A method as recited in claim 1, wherein said negotiated set of specifications is revised by said buyer after said buyer and said selected printer agree to said negotiated set of specifications and said corresponding negotiated price, said selected printer providing said buyer with an invoice price based on a revised set of specifications.

5. A method as recited in claim 4, wherein said invoice price is provided to said buyer after completion of said print job.

6. A method as recited in claim 4, further comprising the step of receiving, into said computer system, said revised set of specifications and said invoice price.

7. A method as recited in claim 4, wherein said invoice price is itemized as to each component in said revised set of specifications.

8. A method as recited in claim 4, further comprising the steps of:
calculating a second estimated price with respect to said selected printer based on pricing information provided by said selected printer for each component in said revised set of specifications; and
comparing said second estimated price to said invoice price of said print job to determine whether said invoice price complies with said pricing information provided by said selected printer.

9. A method as recited in claim 8, further comprising the step of penalizing said selected printer if said invoice price is substantially higher than said second estimated price.

10. A method as recited in claim 9, wherein the step of penalizing said printer comprises the step of causing said printer to reimburse to said buyer at least a part of the difference between said invoice price and said second estimated price.

11. A method as recited in claim 1, wherein said first and second printers are individually selected by said buyer.

12. A method as recited in claim 1, wherein said first and second printers are selected by said computer system based on attributes desired by said buyer.

13. A method as recited in claim 1, wherein said first and second printers are selected by said computer system based on geographical locations of said first and second printers relative to said buyer.

14. A method as recited in claim 1, wherein said first and second printers are prequalified by said computer system to participate in the print supply marketplace.

15. A method as recited in claim 1, wherein said first and second printers are prequalified based on a plurality of qualitative factors, including at least one factor selected from the group consisting of:
business structure;
printing capability;
account management;
reporting capability;
quality certification,
technology; and
availability of discount pricing.

16. A method as recited in claim 15, wherein said first and second printers are prequalified based on a quantitative evaluation including an analysis of a plurality of pricing components provided by said first and second printers.

17. A method as recited in claim 1, wherein the steps of calculating said first and second estimated prices each comprises the steps of:
calculating a manufacturing component based on pricing information provided by respective ones of said first and second printers; and
calculating a raw material component based on paper requirements of said respective ones of said first and second printers.

18. A method as recited in claim 17, wherein said raw material component of said first and second estimated prices is shielded from said first and second printers.

19. A method as recited in claim 17, further comprising the step of informing a paper vendor of said set of specifications and an amount and type of paper required to produce said print job so as to allow said paper vendor to contact said buyer to negotiate at least one of said amount of paper and said type of paper to arrive at said raw material component

20. A method as recited in claim 19, further comprising the steps of penalizing said paper vendor if said paper vendor overcharges said buyer.

21. A method, implemented on a computer system, for operating a print supply marketplace based on a pricing model, comprising the steps of:
receiving into said pricing model, pricing information for each component of a print process from each of first and second printers;
receiving, from a buyer, a set of specifications for a print job desired by said buyer;
determining, from said pricing model, a first set of component prices based on said set of specifications and associated with said first printer;
calculating a first price estimate based on said first set of component prices;
determining, from said pricing model, a second set of component prices based on said set of specifications and associated with said second printer;
calculating a second price estimate based on said second set of component prices;
notifying said buyer of the lower of said first and second price estimates; and
providing at least one of said first and second printers with said set of specifications and respective ones of said first and second price estimates to allow said at least one of said first and second printers thus provided with said set of specifications to contact said buyer and to negotiate said set of specifications and said respective price estimate.

22. A method as recited in claim 21, wherein said buyer selects one of said first and second printers to perform said print job based on a negotiated set of specifications and a corresponding negotiated price.

23. A method as recited in claim 21, wherein said steps of determining said first and second sets of component prices and said steps of calculating said first and second price estimates are performed only with respect to printers selected by said buyer.

24. A method as recited in claim 21, wherein said steps of determining said first and second sets of component prices and said steps of calculating said first and second price estimates are performed with respect to printers selected by said computer system based on attributes desired by said buyer.

25. A method as recited in claim 21, wherein said steps of determining said first and second sets of component prices and said steps of calculating said first and second price estimates are performed with respect to printers selected by said computer system based on said set of specifications.

26. A method as recited in claim 21, wherein said first and second printers are prequalified to participate in said print supply marketplace.

27. A method as recited in claim 26, wherein said first and second printers are contractually bound to provide pricing in accordance with said pricing model.

28. A method as recited in claim 21, wherein the one of said first and second printers selected by said buyer to perform said print job purchases raw material used in said print job from a designated vendor.

29. A method as recited in claim 28, wherein a price of said raw material is included in said first and second price estimates.

30. A method as recited in claim 29, wherein said buyer pays said designated vendor directly for said raw material.

31. A method, using a computer system, for ensuring compliance with a pricing model, comprising the steps of
estimating, based on said pricing model, a first price for a print job to be printed in accordance with a first set of specifications, wherein said first set of specifications may be modified to result in a second set of specifications, said print job thus being printed in accordance with said second set of specifications;
estimating, based on said pricing model, a second price in accordance with said second set of specifications; and
comparing said second price to an invoice price of said print job to determine whether said invoice price complies with said pricing model, said invoice price complying with said pricing model if said invoice price is not substantially higher than said second price.

32. A method as recited in claim 31, further comprising the step of penalizing a printer of said print job if said invoice price does not comply with said pricing model.

33. A method as recited in claim 32, wherein the step of penalizing said printer comprises the step of causing said printer to reimburse to a buyer of said print job at least a part of the difference between said invoice price and said second price.

34. An apparatus for estimating a price for a print job, comprising:
a computer system associated with a print supply marketplace; and
a computer program, performed by said computer system, for receiving a set of specifications for said print job, calculating first and second estimated prices for said print job based on said set of specifications and pricing information provided by first and second printers, informing a buyer of said print job of at least a lower of said first and second estimated prices, and informing said first and second printers of said set of specifications and an identity of the buyer;
wherein said first or second printer can contact said buyer to negotiate at least a portion of said set of specifications; and
wherein said buyer may select one of said first and second printers to perform said print job based on a negotiated set of specifications and a corresponding negotiated price.

35. An apparatus as recited in claim 34, further comprising:
a pricing database for storing said pricing information from said first and second printers.

36. An apparatus as recited in claim 34, wherein said negotiated set of specifications is revised by said buyer after said buyer and said selected printer agree to said negotiated set of specifications and said corresponding negotiated price, said selected printer providing said buyer with an invoice price based on a revised set of specifications, said apparatus further comprising:
a computer program for calculating a second estimated price with respect to said selected printer based on pricing information provided by said selected printer for each component in said revised set of specifications and comparing said second estimated price to said invoice price to determine whether said invoice price complies with said pricing information.

37. A method, using a computer system, for determining a price for a print job, comprising the steps of:
receiving, from a buyer, a set of specifications for said print job, wherein said set of specifications specifies at least a portion of a plurality of components into which a print process is divided, said portion thus specified being required to produce said print job;
calculating an estimated price for said print job with respect to a printer based on pricing information provided by said printer for each of said components thus specified;
informing said buyer of said estimated price; and
informing said printer of said set of specifications and an identity of said buyer so as to allow said printer to contact said buyer to negotiate at least a portion of said set of specifications, wherein said buyer may select said printer to perform said print job based on a negotiated set of specifications and a corresponding negotiated price.

38. A method as recited in claim 37, wherein said negotiated set of specifications is revised by said buyer after said buyer and said printer agree to said negotiated set of specifications and said corresponding negotiated price, said printer providing said buyer with an invoice price based on a revised set of specifications.

39. A method as recited in claim 38, further comprising the steps of:
calculating a second estimated price with respect to said printer based on pricing information provided by said printer for each component in said revised set of specifications; and
comparing said second estimated price to said invoice price of said print job to determine whether said invoice price complies with said pricing information provided by said printer.

40. A method as recited in claim 39, further comprising the step of penalizing said selected printer if said invoice price is substantially higher than said second estimated price.

41. A method as recited in claim 40, wherein the step of penalizing said printer comprises the step of causing said printer to reimburse to said buyer at least a part of the difference between said invoice price and said second estimated price.
